(19) United States
(12) Patent Application Publication
(10) Pub. No.: US 2017/0321641 A1
(43) Pub. Date: Nov. 9, 2017

(54) COMMON-RAIL INJECTION DEVICE AND METHOD OF INJECTING A PREDETERMINED VOLUME OF FUEL

(71) Applicant: FMP TECHNOLOGY GMBH FLUID MEASUREMENTS & PROJECTS, Erlangen (DE)

(72) Inventors: Franz DURST, Langensendelbach (DE); Yu HAN, Nuernberg (DE); Hussain Abdul Hussain RATLAMWALA, Ingolstadt (DE)

(21) Appl. No.: 15/527,200

(22) PCT Filed: Nov. 18, 2015
(86) PCT No.: PCT/EP2015/077023

§ 371 Date: May 16, 2017

(30) Foreign Application Priority Data
Nov. 18, 2014 (EP) 14193671.6

(51) Int. Cl. F02M 37/00; F02D 41/38

(52) U.S. Cl. CPC F02M 37/0041; F02D 41/3827; F02M 2200/247; F02D 2250/04

(57) ABSTRACT

When fuel injections into Otto-engines are carried out, pressure pulsations occur in the entire fuel injection system. These prevent detailed information about the fuel injection to be deduced from the pressure signals measurable in the system. When specially designed dampers for these pressure pulsations are employed, pressure difference signals over the pulsation damper can readily be employed for instantaneous volume flow rate measurements. Furthermore, the inserted pressure pulsation dampers also allow the pressure reduction in the Common-Rail, due to the fuel injections, to be employed to measure the instantaneous fuel injection volume flow rates, in running Otto-engines. The authors' development work in this field is described in this paper and results of verification measurements are presented.

The invention refers to a Common-Rail injection device as well as to a method of injecting a predetermined volume of fuel.

To fulfill the more and more tight requirements of emission legislations and fuel economy needs, many new technologies have recently been developed to improve fuel direct injection systems for internal combustion engines. An important trend of the still ongoing R&D works is the precise control of the injected fuel quantity into the cylinders, as demanded by the engine load dependent combustion processes. In modern diesel injection systems, this is usually achieved by the selection of the injector, the start of the injection and the coordination of the injection pressure and the valve opening time. In this context, many new developments emerged in the last years, such as new magnetic/piezoelectric actuators with optimized opening and closing properties, optimization of the needle structure, and improvements of the injection orifice geometries, etc. In spite of this, the control of the fuel injection is still far from being perfect. Due to the rapid opening and closing of the injector valves, pressure pulsations are caused that penetrate throughout the entire injector system. Usually, such pressure pulsations propagate at the speed of sound and travel from one injector to the other passing the connecting pipes and also the Common-Rail. The maximum amplitude of these pressure pulsations can reach up to ±30% of the mean injection pressure. Since the flow rate through the injector nozzles is proportional to the pressure difference from the pre-chamber to the inside of the cylinder, pressure pulsations will cause different fuel flow rates through the individual injection into the cylinder. Hence, even though the opening time of the injector valves can be precisely controlled, the pressure pulsations distort the attempt of well-controlled fuel-air ratio adjustments for the combustion process. Pressure pulsation dampers are needed for a better control of the fuel injection into the cylinders of Otto-engines.

There are numerous pressure pulsation dampers described in the literature and also within various patents (e.g. see patents [1, 2, 3, 4, 5, 6] and articles [7, 8, 9, 10]). Most of these dampers work on the principle of detuning of a resonator section in an injector, producing a basic frequency of:

$${f}_{B} = \frac{C}{4 {L}_{CN}} \qquad ( 1 )$$

where C is the velocity of sound of petrol and L_{CN} is the length of the considered injector from the Common-Rail to the nozzle exit. Placing an orifice at the Common-Rail exit, detunes the resonator and for a frequency of C=2L_{CN} a damping of the basic frequency of equation (1) occurs. Pressure pulsation damper of this type are available for Otto-engines.

There are other damping mechanisms employed for injector systems nowadays introduced in Otto-engines. The reader is referred to the literature to learn about the different pressure pulsation dampers employed in internal combustion engines. For the present work the damping employed in ref. [11] is of particular interest since it employs the same pressure damping mechanism as that used in the authors work. The latter utilizes the viscous damping of the pressure pulsations:

E_{diss}=(\dot{\tilde{V}}+\dot{V}ₚᵤₗ)ΔP (2)

and the fact that \dot{V}ₚᵤₗ-pulses move with the velocity of sound, i.e. about 10-times faster than the fluid pulse. Being reflected at the end of the authors ring type pressure pulsation damper, the \dot{V}ₚᵤₗ-pulses penetrate several times the energy dissipation section in the time the fluid flow pulse penetrates it only once. Hence, the dissipations are as follows:

$${( {E}_{diss} )}_{\tilde{\dot{V}}} = \frac{8 μ \tilde{\dot{V}} L}{π r 4} \qquad ( 3 )$$

Thus

$${E}_{diss} = N \frac{8 μ {\dot{V}}_{pul} L}{π {r}^{4}} ( N \approx 10 ) \qquad ( 4 )$$

All this is described in the authors patent applications DE 10 2012 212 745 A1 and PCT/EP2013/065318.

The object underlying the present invention is to provide a Common-Rail injection device by which fuel quantity injected into the cylinders can precisely be controlled. In particular, pressure pulsations penetrating through the entire injector system shall be avoided.

The object is solved by the features of claims 1 and 4. Embodiments of the invention are described by the features of claims 2 and 3.

In order to control the volume v of fuel to be injected by the control device there can be controlled a valve, a piezoelectric injection device or the like.

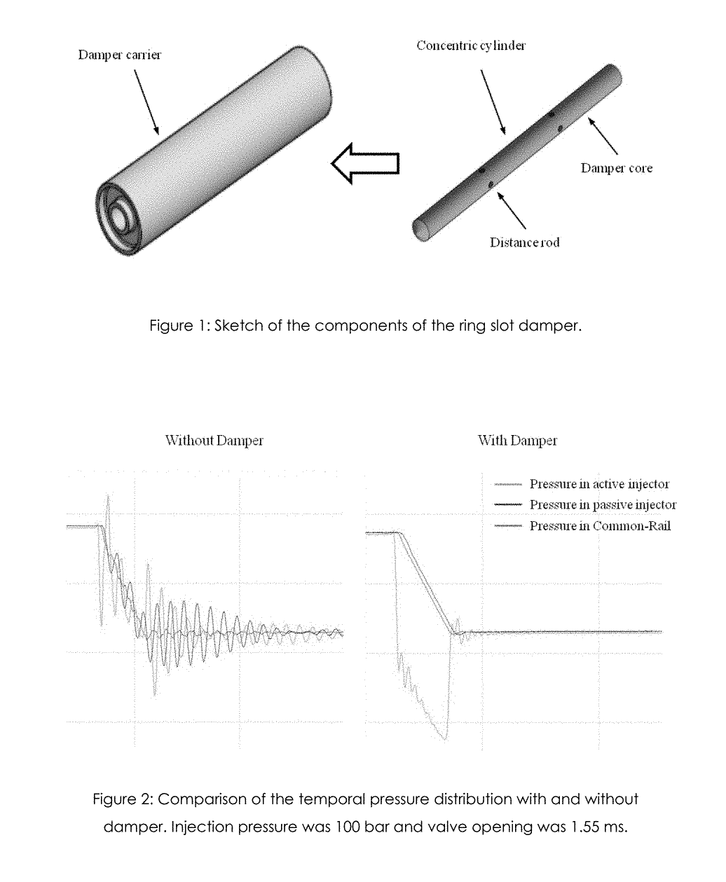

In the present work the authors' layed out, designed, built and employed one of their ring-type pressure pulsation damper to eliminate all pressure pulsations due to the opening and closing of the injector valves. A sketch of the ring slot damper is shown in the FIG. 1. This damper, in the present work, consisted of three parts, namely the damper carrier, the concentric cylinder and the distance rod. The damper carrier is design for the integration in the connection pipe between the Common-Rail and the injector. The concentric cylinder, with special length and diameter dimension, was inserted into the damper carrier and placed in the center of the carrier. This is achieved by the distance rods lying in perpendicular directions to the concentric cylinder, with the same gap length out of the cylinder surface. In this way, the width of the slot was kept constant over its entire length. The inner diameter of the damper carrier Dᵢₙ, together with the cylinder diameter, Dₒᵤₜ, define the width of the slot.

This results, obtained using a commercial injector BOSCH HDEV 5.2 combined with and without damper, are shown in pressure signals in the FIG. 2. It is clear that the pressure pulsations can be significantly reduced when the above damper is introduced between the injector and the Common-Rail. The valve opening time, the pressure drops in the injector as well as in the Common-Rail, can be very well recognized for the measuring case with the employed slot type damper.

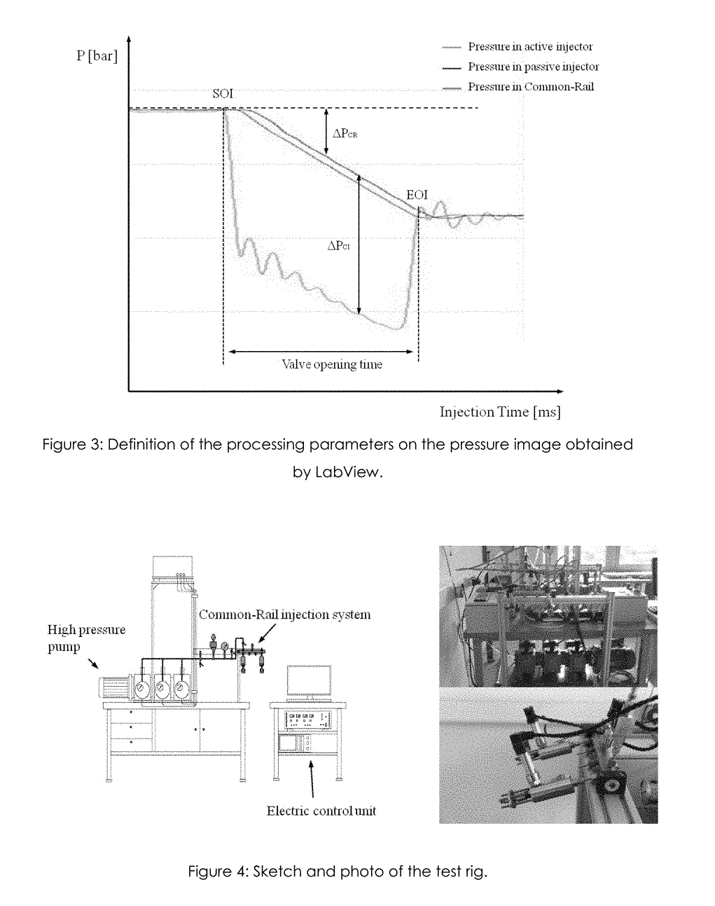

FIG. 3 shows the details of the results obtained with the damper, an injection pressure of 130 bar and pulse width of 2 ms. The temporal pressure distributions, in the Common-Rail, in the active injector and in the passive injector, are almost linear and parallel to each other. The start of injection (SOI) and end of injection (EOI) can be easily determined by the intersections of the two pressure curves. The pressure drops, before and after the damper, can be modeled as linear functions of injection time. The well defined pressure curve and valve opening time, during the injection, provide all necessary information for calculation of the instantaneous injection volume rate.

Based on the temporal pressure distributions, the instantaneous flow rate during the injection can be obtained using the following equation:

$$\dot{V ( t )} = \frac{π {D}_{in} {δ}^{3}}{12 μ L} Δ {P}_{CI} ( t ) \qquad ( 5 )$$

where ΔP_{CI}(t) is the pressure difference before and after the damper (see FIG. 3), Dᵢₙ is the inner diameter of the ring slot, δ is the slot with δ<<Dᵢₙ, μ is the dynamic viscosity of the fuel and L is the effective length of the ring slot. The theoretical modeling is based on the volume flow rate through a small rectangular channel. The detailed information can be found in [11], [12] and [13]. The instantaneous flow rate can be used for investigations of the needle action, the pressure change and the actual injection time etc. during the injection.

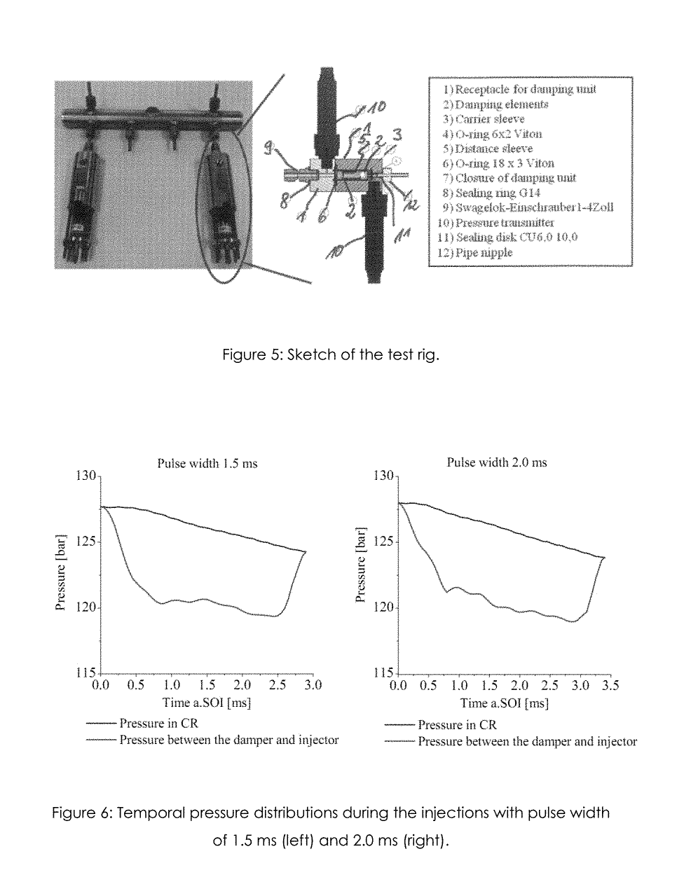

The total injected fuel amount, with a closed value between the Common-Rail and the fuel pump, is theoretically only dependent on the pressure loss in the Common-Rail. As shown in the FIG. 5, by introduction of the ring-slot damper in the measurements, the pressure distribution in the Common-Rail is almost a straight line during the injection. Hence, the total injected fuel amount can be easily modeled as:

Mᵢₙⱼ=ρ_{f}∫₀^{t}^{_{end}}cₛΔP_{CR}(t)dt (6)

Where Mᵢₙⱼ is the total mass injected, ρ_{f} is the fuel density, cₛ is a system dependent constant and ΔP_{CR}(t) is the time varying pressure drop in the Common-Rail. Thus, by integrating the pressure lost in the Common-Rail during the valve opening time, the total injected mass by one injection can be obtained as Eq. (6).

Hence, two ways are described above to measure the instantaneous flow rates from the pressure signal detected from the pressure difference over the employed pulsation dampers or deduced from the pressure in the Common-Rail.

A manufactured pressure pulsation damper was applied, in a test rig, to test its performance and, at the same time, to develop new methods to determine the injected mass flow rate. As shown in the FIG. 4, the experimental setup consists of a fluid supplying system, a high-pressure pump, a Common-Rail injection system and the electric control unit. A rail pressure up to 220 bar could be produced in the Common-Rail by adjusting the rotation speed of the pump. A valve was placed between the Common-Rail and the fuel pump to exclude the influence of the pump in the system during the flow rate measurements. A pressure sensor was mounted on the Common-Rail to record the temporal pressure distribution during the injection. Commercial injectors of the type “Bosch HDEV 5.2”, with an electromagnetic valve, were applied to make the injections. The injection controlling signal was generated by a signal generator driven by the LabVIEW that was employed to control the start of the injection and the duration of the injection.

A detailed description of the setup of the carriers of the pressure pulsation dampers is shown in the FIG. 5. Two pressure sensors were mounted on the damper housings (see the blue parts in the FIG. 5), in order to measure the pressure before and after the employed pulsation dampers. The instantaneous pressure was measured as a voltage signal by the sensors and then transmitted to digital signals by the data acquisition system. These digital signals were exported to MATLAB where they were processed to calculate the actual injector valve opening time (this is because of the inability of the magnetic valves to respond timely to the pulse signal) and the pressure drop in Common-Rail. Through this pressure drop and valve opening time the injected volumetric flow rate can be calculated.

Note that the pressure oscillations induced by the fuel pump were excluded by closing the valve between the pump and the Common-Rail during the injection. Since the pressure pulsations generated by the fuel pump contribute only in a minor way, compared to the pressure pulsation caused by the opening and closing of the injector valve. Therefore, in order to provide a detailed understanding of the valve-induced pressure pulsations, in the present work, the individual injections were carried out at constant Common-Rail pressure.

As mentioned before, in the authors' verification experiments, the raw signals from the pressure sensors were transmitted to the software MATLAB and a pre-programmed data processing was carried out. The injection time and pressure distributions, during the value opening, were extracted based on the two intersection points of the pressure curves in Common-Rail and the injector, see FIG. 3. Two examples, obtained with Rail pressures of about 127 bar and signal pulse widths of 1.5 ms and 2.0 ms, are shown in the FIG. 6. All other measurements, with different injection parameters, provided very similar results as those shown in the FIG. 6 and, therefore, only the example in the FIG. 6 shown here.

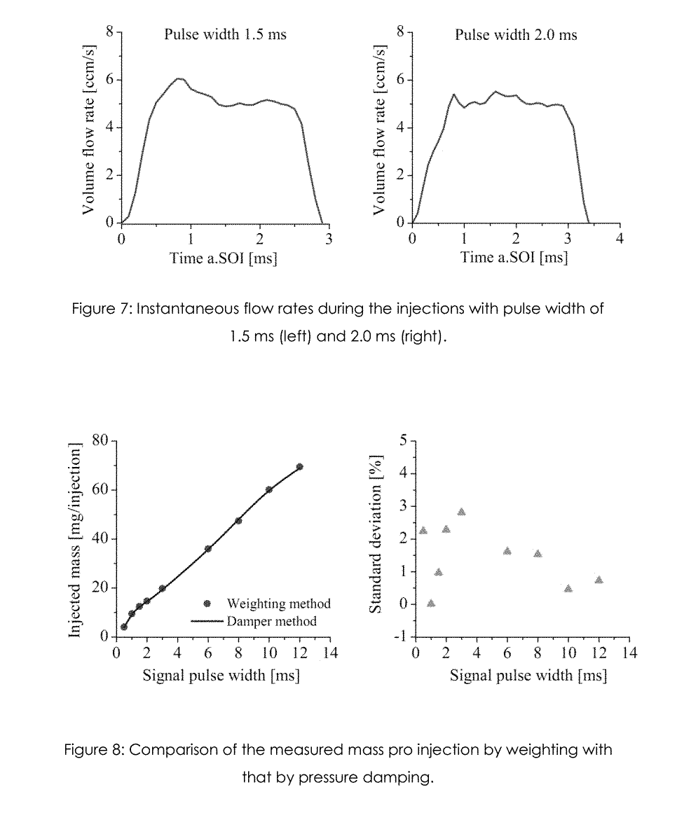

The instantaneous flow rate of the injection can be determined using Eq. (5). The obtained results with injection time of 1.5 ms and 2.0 ms are plotted in the FIG. 7. The results show clearly that the instantaneous flow rate during one injection consists of three phases, namely the building-up phase for the injection flow rate, the actual injection phase and the closing-down phase. From these diagrams, the time of needle lift-up, main injection and needle shut-down can be quantitatively defined and the outlet velocity at the orifice exit can be easily obtained by the quotation of the volume flow rate to the cross-section area of the orifice. For example, with the injection time of 1.5 ms, the valve reacting time was about 0.6 ms and the actual valve opening time was about 2.8 ms. The volume flow rate of the main spray was approximately 5 ccm/s, but varying with the injection time.

In order to verify this method of injection flow rate measurements, the total injected mass of one injection was measured by collecting the total mass of a number of injections and then by measuring their weight using a high-accurate electric balance. The obtained pressure signals were processed using the upper described method and the obtained results were compared with the experimental measurements in the FIG. 8. The figure shows clearly that the developed method offers very good agreement with the total mass weight method for different injection times. The maximum of the standard deviation between two methods are approximately 3%.

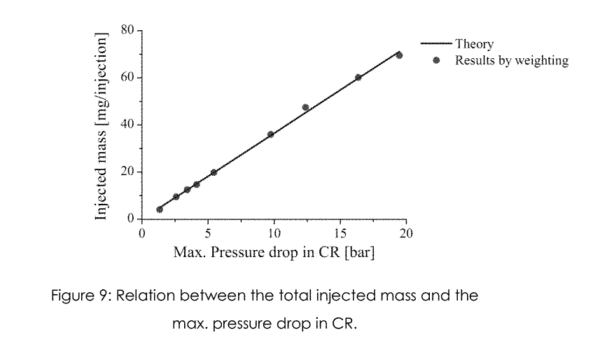

Furthermore, due to the fact that the valve between fuel pump and the Common-Rail was closed during this set of experiments, the pressure loss of the Common-Rail during the injection is solely because of its volume loss. Hence, the total injected mass can also be determined by the temporal pressure distribution in the Common-Rail. The points in FIG. 9 indicate the relation between the measured injected mass and the maximal pressure drop ΔP_{CR,max} in the Common-Rail. A linear distribution can be obtained, between the total injected mass and the maximal pressure drop in the Common-Rail, in a large range of signal time. That indicates that the injected fuel amount can be easily determined by the pressure signal in the Common-Rail. Our measurement results give a simple correlation for the prediction of the total injected mass:

$${M}_{inj} = \frac{CD {δ}^{3} {ρ}_{f}}{μ L} Δ {P}_{CR , max} \qquad ( 7 )$$

Here C is an empirical constant depending on the system set-up

At present, the fuel injection flow rates into Otto engines can only be measured under laboratory conditions, using the HDA-Moehwald or IAV-system, see refs. [14] and [15], both employing the same measurement method. They employ fluid injection into filled chambers, and, if the compressibility of the injected fuel is known, the instantaneous pressure changes in the chamber can be used to measure the instantaneous flow rate of the employed injector

There have been other attempts to measure instantaneous flow rates in strongly time-dependent flows. Such attempts are described in refs. [16], [17] and [18] and are based on center line velocity measurements in pipes, yielding the one information needed to deduce the entire velocity profile at a certain time. With this profile, the instantaneous flow rate through the pipe could be obtained by integration over the computed velocity profile.

The proposed Common-Rail injection device utilizes inexpensive components that could be mounted into the injection systems of automobiles driven by Otto engines in order to permit instantaneous volume flow rates to be measured utilizing the pressure difference signals over a pulsation damper and/or the pressure reduction in the corresponding Common-Rail.

### REFERENCES

[1] Albert B Niles “Filtering and dampening apparatus”, Oct. 26, 1982, U.S. Pat. No. 4,356,091
[2] Jan Pfingst and Mirko Jacob “Hydraulischer Pulsationsdämpfer”, Oct. 25, 2007, DE 10 2006 016 937 A1
[3] Hitoshi Kino and Terumitsu Oshima “Fuel pressure pulsation damper”, Mar. 22, 1995, Japanese Patent 08261100 A
[4] Hans-Peter Schreurer “Kraftstoffeinspritzungsystem für eine Brennkraft-maschine mit druckschwingungsgedämpfter Kraftstoffrücklauleitung”, May 21, 2008, DE 10 2006 054 178 A1
[5] Andreas Fath “Accumulator injection system for damping pressure waves, especially in a common rail injection system”, Apr. 29, 2004, WO2004/036029 (PCT/DE2003/002868)
[6] Martin Hiller “Verfahren zum verringern von Druckpulsationen”, May 25, 2005, DE 103 51 089 A1
[7] Joe Z Li, Chris Treusch, B. Honel, and S. Neyrat “Simulation of pressure pulsations in a gasoline injection system and development of an effective damping technology”, Technical Report, SAE Technical Paper, 2005
[8] Mohamed S Ghidaoui, Ming Zhao, Duncan A McInnis, and David H Axworthy “A review of water hammer theory and practice”, Applied Mechanics Reviews, 58(1):49-76, 2005
[9] Arthur Handtmann, Dominik Haspel, Lars Schilling, et al. “Druckpulsationsdämpfer fur Injektoren”, MTZ-Motortechnische Zeitschrift, 73(11):870-876, 2012
[10] Franz Durst “Fluid mechanics: an introduction to the theory of fluid flows”, Springer, 2008
[11] Franz Durst “Kraftstoffeinspritzsystem”, Jan. 23, 2014, DE 10 2012 202 745 A1
[12] Franz Durst, Dominik Haspel, Bülent Unsal, and Rainer Resch “Fast-operating injection valves with virtually pressure wave-free supply lines”, MTZ worldwide, 68(10):21-23, 2007
[13] F. Durst, S. Ray, B. Unsal, and O. A. Bayoumi “The development lengths of laminar pipe and channel flows”, Journal of fluids engineering, 127(6):1154-1160, 2005
[14] Moehwald Bosch Group “Einspritzmengen-und Ratenverlaufmessgerät”
[15] Thorsten Kwast, Ralf Marohn, and Thomas Rile, “Verfahren und Vorrichtung zur Einspritzraten-und/oder Einspritzmassenbestimmung”, Mar. 1, 2007, DE 10 2005 040 768 A1
[16] Wilhelm Bosch “The fuel rate indicator: a new measuring instrument for display of the characteristics of individual injection”, Technical report, SAE Technical Paper, 1966
[17] F. Durst, A. Melling, D. Trimis, and P. Volkholz “Development of a flowmeter for instantaneous flow rate measurements of anaesthetic liquids”, Flow Measurement and Instrumentation, 7(3):215-221, 1996
[18] Bülent Unsal, Dimosthenis Trimis, and Franz Durst “Instantaneous mass flowrate measurements through fuel injection nozzles”, International Journal of Engine Research, 7(5):371-380, 2006

1.-4. (canceled)

5. Method of injecting a predetermined volume of fuel into a cylinder by using a common-rail device, comprising a fluid supplying system for supplying fluid to a common rail tube,
a plurality of injectors being connected with the common rail tube,
a fluid pulsation damper being provided between each of the injectors and the common rail tube,
a first pressure sensor being provided upstream of the fluid pulsation damper and being connected for signal transmission with a control device for controlling a volume v of fuel to be injected by the injectors per cycle,
a second pressure sensor being provided between each fluid pulsation damper and a nozzle of each of the injectors, the second pressure sensor being connected for signal transmission with the control device for controlling the volume of fuel to be injected by the respective injector per cycle,
the fluid pulsation damper being a ring slot damper,
wherein the volume is determined by measuring a maximum pressure drop Δp occurring per cycle with the first pressure sensor and by calculating dv/dt on basis of Δp, wherein the instantaneous flow rate during the injection is obtained using the following equation:
$$\dot{V ( t )} = \frac{π {D}_{in} {δ}^{3}}{12 μ L} Δ {P}_{CI} ( t ) ,$$
where ΔP_{CI}(t) is the pressure difference before and after the damper, Dᵢₙ is the inner diameter of the ring slot, δ is the slot width with δ<<Dᵢₙ, μ is the dynamic viscosity of the fuel and L is the effective length of the ring slot.

6. Method of injecting a predetermined mass of fuel into a cylinder by using a common-rail device, comprising
a fluid supplying system for supplying fluid to a common rail tube,
a plurality of injectors being connected with the common rail tube,
a fluid pulsation damper being provided between each of the injectors and the common rail tube,
a first pressure sensor being provided upstream of the fluid pulsation damper and being connected for signal transmission with a control device for controlling a volume v of fuel to be injected by the injectors per cycle,
the fluid pulsation damper being a ring slot damper,
wherein the volume is determined by measuring a maximum pressure drop Δp occurring per cycle with the first pressure sensor and by calculating dv/dt on basis of Δp,
wherein the total injected mass by one injection can be obtained by
$${M}_{inj} = \frac{CD {δ}^{3} {ρ}_{f}}{μ L} Δ {P}_{CR , max} ,$$
where Mᵢₙⱼ is the total mass injection, ΔP_{CR,max} is the maximum pressure drop in the Common-Rail, C is an empirical constant depending on the system set-up, D is the inner diameter of the ring slot, δ is the slot width, μ is the dynamic viscosity of the fuel and L is the effective length of the ring slot.
